(19) United States
(12) Patent Application Publication
(10) Pub. No.: US 2010/0268552 A1
(43) Pub. Date: Oct. 21, 2010

(54) Content Integration Service

(76) Inventors: Ido Schoenberg, Boston, MA (US); Eran David, Tel-Aviv (IL)

Correspondence Address: FISH & RICHARDSON PC, P.O. BOX 1022, MINNEAPOLIS, MN, 55440-1022, US

(21) Appl. No.: 12/764,492

(22) Filed: Apr. 21, 2010

Related U.S. Application Data
(60) Provisional application No. 61/171,186, filed on Apr. 21, 2009.

(51) Int. Cl. G06Q 50/00; G06Q 30/00; G06F 17/30

(52) U.S. Cl. 705/3; 705/34; 707/803; 707/E17.005

(57) ABSTRACT

Among other things, a computer implemented method is described. The method comprises identifying medical information from a plurality of information sources, the medical information having one or more data structures; converting the data structure of the identified medical information into a predefined data structure; and presenting the transformed medical information having the predefined data structure.

### CLAIM OF PRIORITY

This application claims priority under 35 U.S.C. §119(e) to U.S. Patent Application Ser. No. 61/171,186, filed on Apr. 21, 2009, the entire contents of which are hereby incorporated by reference.

### BACKGROUND

This disclosure relates to a service that integrates medical content with a clinical information system.

Hospitals face challenges in dealing with an ever-growing amount of medical and patient information being produced from healthcare facilities. A significant amount of such information resides in various databases and legacy systems, but conventionally these databases and systems do not communicate with one another. Critical patient and medical content are contained within a wide range of sources, such as file systems, web pages, e-mail systems, databases, document management systems, and various types of software platforms. Hospitals often run into situations of data overload and shortage of contextual knowledge shortage in organizing medical information.

### SUMMARY

In an aspect, the disclosure features a computer implemented method. The method comprises identifying medical information from a plurality of information sources, the medical information having one or more data structures; converting the data structure of the identified medical information into a predefined data structure; and presenting the transformed medical information having the predefined data structure.

Implementations may include one or more of the following features. The medical information from the plurality of information sources is periodically updated. Converting the data structure of the identified medical information comprises resolving data structure discrepancies among the information from the plurality of information sources. Presenting the medical information comprises deploying a portal system that is accessible by a plurality of authorized users within a healthcare environment. The portal system comprises a communication gateway module configured to manage data flow and control operations on the identified medical information. The portal system comprises an interface configured to provide access to and enable sharing of the medical information among the plurality of authorized users within a healthcare environment. The method also comprises: assigning each of a plurality of patients a unique identifier; associating the medical information related to each patient with the unique identifier of the patient; and accessing medical information of a patient by referencing the unique identifier. The medical information comprises clinical applications that make use of clinical data. Presenting the transformed medical information comprises enabling a user to browse online a content catalog of the medical information. A user is enabled to download online content applications of the medical information. The user is billed for downloading the content applications.

In another aspect, the disclosure features a system. The system comprises a server computer including a processor. The processor is configured to: identify medical information from a plurality of information sources, the medical information having one or more data structures; convert the data structure of the identified medical information into a predefined data structure; and present the transformed medical information having the predefined data structure.

Implementations may include one or more of the following features. There is a data repository for storing the medical information from the plurality of information sources. To convert the data structure of the identified medical information comprises resolving data structure discrepancies among the medical information from the plurality of information sources. There is a portal system in communication with the server computer, the portal system comprising an interface configured to provide access to and enable sharing of the medical information among a plurality of authorized users within a healthcare environment. The portal system is deployed within a healthcare environment. The portal system comprises a communication gateway module configured to manage data flow and control operations on the identified medical information. The processor is configured to periodically update the medical information from the plurality of information sources. The processor is configured to: assign a unique identifier to each of a plurality of patients; associate medical information that is related to each patient with the unique identifier of the patient; and access medical information of the patient by referencing the unique identifier. The medical information comprises clinical applications that make use of clinical data. To present the transformed medical information comprises enabling a user to browse online a content catalog of the medical information. The processor is configured to enable a user to download online content applications of the medical information. The processor is configured to bill the user for downloading the content applications.

In another aspect, the disclosure features a computer-readable medium for storing instructions that are executable by a computer. The execution of the instructions causes the computer to: identify medical information from a plurality of information sources, the medical information having one or more data structures; convert the data structure of the identified medical information into a predefined data structure; and present the transformed medical information having the predefined data structure.

Implementations may include one or more of the following features. The computer is caused to store the medical information from the plurality of information sources in a data repository. To convert the data structure of the identified medical information comprises resolving data structure discrepancies among the medical information from the plurality of information sources. The computer is caused to provide access to and enable sharing of the medical information among a plurality of authorized users within a healthcare environment. The computer is deployed within a healthcare environment. The computer is caused to manage data flow and control operations on the identified medical information. The computer is caused to periodically update the medical information from the plurality of information sources. The computer is caused to: assign a unique identifier to each of a plurality of patients; associate medical information that is related to each patient with the unique identifier of the patient; and access medical information of the patient by referencing the unique identifier. The medical information comprises clinical applications that make use of clinical data. To present the transformed medical information comprises enabling a user to browse online a content catalog of the medical information. The computer is caused to enable a user to download online content applications of the medical information. The computer is caused to bill the user for downloading the content applications.

Among other advantages, the content integration service connects medical content providers and is used mainly for decision support (e.g., drugs database, evidence base medicine, rules and alerts) for their service customers (e.g., hospitals, health organization) through the use of, for example, Electronic Medication Records (EMR) systems.

Among other advantages, the content integration service provides an online catalog of content products that the service customers can browse and from which content applications can be downloaded. The content integration service may also provide services for billing the service customers for actual content use (e.g., subscription base, per-use).

The details of one or more implementations are set forth in the accompanying drawings and the description below. Other features, objects, and advantages of the invention will be apparent from the description and drawings, and from the claims.

### DESCRIPTION OF DRAWINGS

FIG. 1 illustrates a medical content integration system.

FIG. 2 is a block diagram of a medical content integration system integrating a plurality of information sources and applications.

FIG. 3 is a block diagram of a gateway module of a medical content integration system.

FIG. 4 is a flowchart of operations of an integration manager.

FIG. 5 is a block diagram that represents a computer system and related components

### DETAILED DESCRIPTION

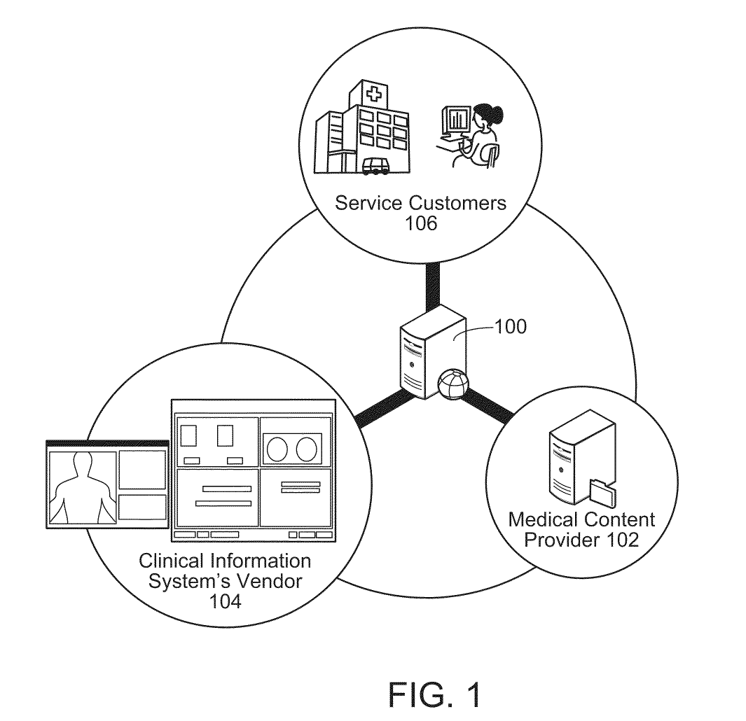

Medical content (or medical information) may generally include patient information clinical applications, smart alarms, clinical publications, and other types of information that contains medical knowledge. Medical content can be included in various sources, such as doctor's notes, clinical data, results of medical tests and diagnosis, public publications, research results, and many others, which may take one or more forms (e.g., located in paper format, electronic format, etc.) that may be dependent upon geography (e.g., come in different formats at different geographic locations). Referring to FIG. 1, a computerized content integration service system 100 receives, processes, integrates, medical content from various sources, e.g., a medical content provider 102, a clinical information system vendor 104, and service customers 106. The service system 100 also provides integrated information to the sources so that the users at these sources can also retrieve and use the integrated information. For example, a user can browse online a content catalog of the integrated information. The user can also download online selected content applications, e.g., for use on patients. The service system 100 can bill the user for content use, e.g., subscribing the integrated information or downloading content applications.

In general, the service system 100 provides an interface and boundaries for each of the engaging participants who provide the medical content to be integrated or who retrieve integrated medical content. For example, the medical content provider 102 can implement a set of interfaces (e.g., graphical user interfaces (GUI), not shown) that allow the service system 100 to integrate applications, e.g., software applications that provide functions, in a pre-defined manner, e.g., based on the type of the provided medical content. For example, to integrate the medical content including drug databases (e.g., a prescription drug database, an FDA drug database) provided by the medical content provider 102, the service system 100 may use a set of services compatible with Electronic Medication Records (EMR) systems workflow, and a set of services associated with backend alerts. In some examples, the medical content provider 102 can deploy the applications of the medical content to locations that can be accessed by the service (e.g., the service may provide hosting).

The clinical information system's vendor 104 is often referred to as an EMR system vendor 104. EMR systems generally keep track of a patient's entire health and medical history in a computerized, electronic format. By retaining such electronic records, patient medical information can be easily retrieved, and the records may be efficiently navigated within the stored information. In some arrangements, the EMR systems may store two types of records. For one type, records may be scanned and stored in a graphic format (e.g., a “.pdf” format). Such records can include doctor notes, test results such as x-rays results ultrasounds results, or MRI results. In some situations, some of these records are recorded by hand and can be illegible. A second type of records may be electronically created or captured and maintained as an electronic record. For example, some doctor notes may be entered electronically directly into an electronic record during the discussion between the doctor and the patient, or when a prescription is issued directly from a computer printer. Along with being created in an electronic format, such records may be updated, combined and stored in electronic form.

An EMR system can perform at least four functions: computerized orders for prescriptions, computerized orders for tests, reporting test results, and recording physician notes. In some implementations, the EMR system uses standards of a facility or insurance company to determines which received record is to be kept and maintained within the EMR system. Considering the independency and complexity of the EMR system, vendors of such systems may need a set of interfaces to attain and analyze the medical content provided by the service system 100. There are different types of interfaces depending on the type of medical content that the EMR system vendors choose to support.

The service customers 106, such as hospitals and health organizations, may use a portal for purchasing new medical content, and review and interact with previously purchased medical content. Such a portal may also allow multiple users and terminals sharing the same service system 100 to map each user's custom terminology to a standard terminology used in the service system 100, e.g., supported by a service dictionary, thereby facilitating use of standardized clinical vocabularies (e.g., reference information model (RIM) version HL7, Systematized Nomenclature of Medicine—Clinical Terms (SNOMED-CT), and Logical Observation Identifiers Names and Codes (LOINC)) in user communications.

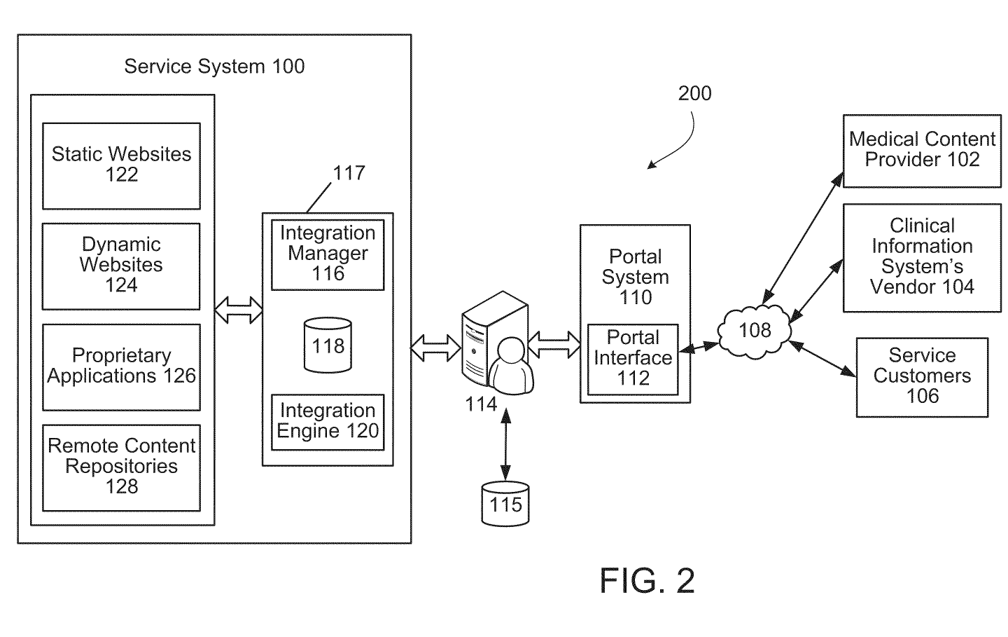

In addition, by linking the medical content provider 102, the EMR system vendors 104, and the service customers 106, the content integration service system 100 may serve as a sale platform for content applications. In some implementations, the medical content providers 102 can use the service system 100 to publish their goods for sale and create a market between customers and sellers. For example, a physician, e.g., a doctor at an intensive care unit (ICU) department, can log into a medical content portal (e.g., portal system 110 in FIG. 2) to research the state-of-art medical device or methodology in cardiovascular diseases. The physician can review the recently produced knowledge or developed technology, e.g., by a university subsidiary. The physician may also find devices or methods for detecting of heart failure (or other ailments) at an early stage, e.g., using a warning algorithm. The physician can also review an overview of a company that provides the devices or methods through the portal, as well as possibly receive feedback from colleagues using the devices or methods. Based on the review, the physician can choose to subscribe to the information provider, the devices, the application, or the methods.

In some implementations, the system can identify updates for methods or devices of interest. For example, when an older versions of the methods or devices, which a physician has interest in obtaining, has already been purchased or used, the system 100 can identify the old methods or devices and find the portion of the method or device that needs to be updated in view of a newer version. In one situation, a warning algorithm may use five vital sign parameters and three are already being used by the hospital at which the physician works. The service system 100 can allow the physician to map the existing “parameters” available through the Clinical Information System's vendor (e.g., the EMR vendor) with the remaining parameters that the algorithm product requires.

After the physician completes the online subscription and terminology mapping, the content application, e.g., the product algorithm, will be deployed at the service customer environment and be applied on the patients of the physician. Later, the physician may browse a web page (e.g., titled “My Active Subscriptions”), e.g., using a user interface (UI), and evaluate the effectiveness of the methods (e.g., how often the methods are used) and decide whether to renew the subscription.

Referring to FIG. 2, a system 200 uses the medical content service system 100 to integrate disparate medical information received from a variety of sources to produce integrated medical content stored in a central data repository 115 and accessible through a computer implemented client-server software architecture network. The integrated medical content contains information from clinical information system within a healthcare environment, e.g., a hospital, and allows physicians to provide services based on a timely, reliable, integral, and context-relevant information service. In a dynamic clinical setting where time-pressed medical doctors or practitioners need reliable information immediately to diagnose and treat patients, the service system 100 may be deployed across organizational and repository boundaries to provide the physicians with improved search capabilities and integrated access.

Medical content integration may be implemented by defining a portal interface 112 of a portal system 110. The portal interface 112 communicates with the medical content provider 102, the clinical information system vendors 104, and the service customers 106 through a wired or wireless network 108 (e.g., local area networks (LANs), wide area networks (WANs), and/or regional networks accessible over telephone lines, such as commercial information services). The physical locations of the content integration service can be outside of the customer premises (e.g., a hosting environment) that is capable of providing services to multiple customers based on a centralized data center. For example, the service for mapping and transforming of medical data may be deployed in a hosted environment outside of the hospital premises. Other information sources containing relevant medical knowledge may also be channeled into the portal system 110 (e.g., also through the network 108) to form a network of connected applications, e.g., running in a so-called “cloud computing” topology.

In some implementations, the portal system 110 acts as an interface between the network 108 and a server 114. The portal system 110 may be a multiple-access internal portal configured to allow multiple end-users, e.g., the service customers 106, the medical content provider 102, or the EMR system vendors 104, to share functionalities (logic and data) provided by the central content server 114 and a content control system 117 through the portal interface 112. In some implementations, the portal system 110 may include a single sign on (SSO) feature which provides single access point to available content. Since content integration provides the ability to share data (e.g., unstructured data), images and documents, data may be transported from the source locations to other locations when needed. Data conversions are typically performed when different applications are used. The service customers 106 may typically need services such as: a) check-in/check-out capabilities; b) version control, so that successive versions of a particular record item can be retained or overwritten; c) a security system, by which content can be protected from unauthorized review or manipulation; d) workflow, which establishes a process through which a document or request flows among the users of the portal system 110; and e) a terminology mapping among systems. As such, organizational mechanisms may be provided to create a content structure that is easily browsed by portal users. In addition, medical contents can be shared among different databases through replication, file transfer, synchronization processes, and etc. Each individual user's data and applications may be configured, optimized, and maintained locally. In some implementations, requests from each user to the server 114 are configured not to interfere with other clients' applications and database servers.

In some implementations, the medical content provider 102, the clinical information system vendors 104 and the service customers 106 communicate with the service system 100 via different operating systems and applications, e.g., software applications. In such implementations, medical content integration occurs on various platforms and/or operating systems. The server 114 may be configured to aggregate various medical contents from a broad range of internal and external sources and platforms. As shown, by bridging different applications (e.g., integration manager 116, integration engine 120), content repository 118, and a portal interface 112, the server 114 provides facilities to store, view, import/export, organize, modify, and request medical information. Security may be enhanced by authenticating appropriate access rights of each user.

In some implementations, the medical content may be categorized into various repositories and/or logical groups within the service system 100. For example, information may be categorized or stored as static websites 122. Static websites generally refer to HTML pages (i.e., web pages) that display the same information for all users. Although they may be updated from time to time, static websites generally do not change their presented content for each user access. Dynamic websites 124, on the other hand, can display different content based upon user interaction and are widely adopted in e-commerce and online ordering. Information can also be gathered from or saved into various proprietary applications 126 deployed within the system 200. Remote content repositories 128 may include industry and government references such as codes associated with federal regulations and databases (e.g., a patent database). These applications usually call for a user to login and provide authentication for approved access.

Data and information may be stored in these repositories and logical groups 122, 124, 126, 128 in a variety of data structures. An integration engine 120, also included in the content control system 117, can be configured to map and transform contents from one data structure into another data structure, via a form of messages or web service calls. The integration manager 116 can be configured to resolve inconsistencies among various formatted content sources (e.g., HL7, Web Services Description Language (WSDL), or in a custom format). In the event of detection of discrepancies in the format conversion process, the integration manager 116 may be configured to request human intervention to resolve the problem. In some implementations, a generic presentation format can be defined to realize content aggregation. In such implementations, available medical contents including text, graphics, styles, themes, and other properties may be stored as objects in a relational database. Such objects may have XML (Extensible Markup Language) schemas in a high performance relational database.

In some implementation, medical information or content may be stored in two or more dynamic content repositories. The system 100 can import information updates into each dynamic content repository. Synchronizing such information updating among two or more dynamic content repositories can be performed according to a schedule, periodically (e.g., every other hour, everyday, and the like), and/or on an as-needed basis. Examples of information updates include, without limitation, periodically issuing medical publications, newly-acquired patient related data, and software upgrades. In some implementations, information updates are automatic and may be transparent to users.

When implemented in a specific healthcare setting (e.g., a hospital), the system 200 may prompt the medical content provider 102 to enter data (e.g., in the central data repository 115) by using a set of software applications. These applications may allow the medical content provider 102 to view a daily clinic schedule and select patients. Before a patient's regularly scheduled appointment, a nurse may generate a patient-specific data sheet tailored to present the patient's known conditions and containing alerts and reminders. The content provider 102 may document information using a variety of techniques, such as structured templates, macro text, direct keyboard entry, and voice recognition. During the meeting of the doctor and the patient, the doctor can review clinical data related to the patient, and optionally use the portal system 110, to search for medical literature or related clinical research results that may provide insights as to the causes of patient's symptoms and recommended treatments. At the end of the appointment, a diagnosis of the patient is entered or updated in the central data repository 115, and a prescription may be ordered. A physician may also send a message to office staff to provide the patient with educational materials before the patient leaves.

The system 200 can also be configured to handle other aspects of content integration, including desired software application deployments inside a healthcare environment to provide medical content maintenance and financial services. The financial services may include services for billing customers for content use, e.g., either using a subscription base model or using a pay per use model. In some implementations, the system 200 can handle all financial transactions among the service customers, clinical information system vendor, and content providers. As such, the system 200 can enable a variety of information sources to interact with the service customer 106 in an efficient manner.

In some implementations, the server 114 may be a single server while in other implementations, the server 114 may include multiple, logically-grouped servers. The logical group of servers may be referred to as a server farm. The servers in such a logical group may be geographically dispersed. In some implementations, the server farm may further comprise a plurality of server farms.

The content applications can run over heterogeneous servers 114 within one or more hosting farms. One or more of the servers 114 may operate according to one type of operating system platform (e.g., WINDOWS NT, manufactured by Microsoft Corp. of Redmond, Wash.), while one or more of the other servers 114 may operate on according to another type of operating system platform (e.g., Unix or Linux). The group of servers logically grouped as a farm may be interconnected using a wide-area network (WAN) connection or medium-area network (MAN) connection. For example, a farm may include servers 114 physically located in different continents or different regions of a continent, country, state, city, campus, or room.

Server 114 may be referred to as a file server, application server, web server, proxy server, or gateway server. In some implementations, a server 114 may have the capacity to function as either an application server or as a master application server. In some implementations, one or more medical content providers 102, the clinical information system vendor 104 and the customers 106 communicate directly with the server 114. In some implementations, one or more medical content providers 102, the clinical information system vendor 104 and the customers 106 execute an application on a client computer (not shown) to communicate with the server 114. The client may communicate with the server 114 over the network 108 optionally via the portal system 110. The client may, for example, request execution of various applications hosted by the server 114 and receive output of the results of the application execution for display.

In some implementations, the server 114 provides functions of a web server. The server 114 receives requests from the client, forwards the requests to a second server and communicates the response from the second server to the client. In some implementations, the second server may include the medical content service system 100 as described previously. The second server may be of any type and form as described with respect to the server 114.

The content repository 118 may be configured to store different types and forms of data. For example, the content repository 118 may store and support unstructured data (e.g., computerized information that either does not have a data model or has one that is not easily usable by a computer program), structured data, and user-defined data types, text, image, audio and video data. The content repository 118 may include both relational and object XML data and may be accessed and/or managed by an integration engine 120 and an integration manager 116. For example, the integration manager 116 can be configured to contain schemes that define rules in regards to how XML objects are stored and indexed within the content repository 118. In some implementations, content sources are clustered into categories according to keywords. Relevance ranking with term highlighting can also be performed for the stored content.

The network 108 may include one or more different types of network. For example, the network 108 may include a local area network (LAN), such as a company intranet or a home network. In some implementations, the network 108 may include a metropolitan area network (MAN) or a wide area network (WAN) such as the Internet. In other implementations, the network 108 may include a combination of one or more different types of network. For example, a LAN such as the home network may be connected to an external access network. In such cases, one or more gateway devices may act as interfaces between two different networks.

The network 108 can be of any type and form and may include any of the following: a point to point network, a broadcast network, a computer network, a power line network, an Asynchronous Transfer Mode (ATM) network, a Synchronous Optical Network (SONET), a Synchronous Digital Hierarchy (SDH) network, a wireless network and a wired network. If the network 108 is at least in part a wired network, the network 108 may include one or more of the following: coaxial cable, telephone wires, power line wires, twisted pair wires or any other form and type of wire. The topology of the network 108 may be a bus, star or a ring topology or any other topology capable of supporting the operations described herein.

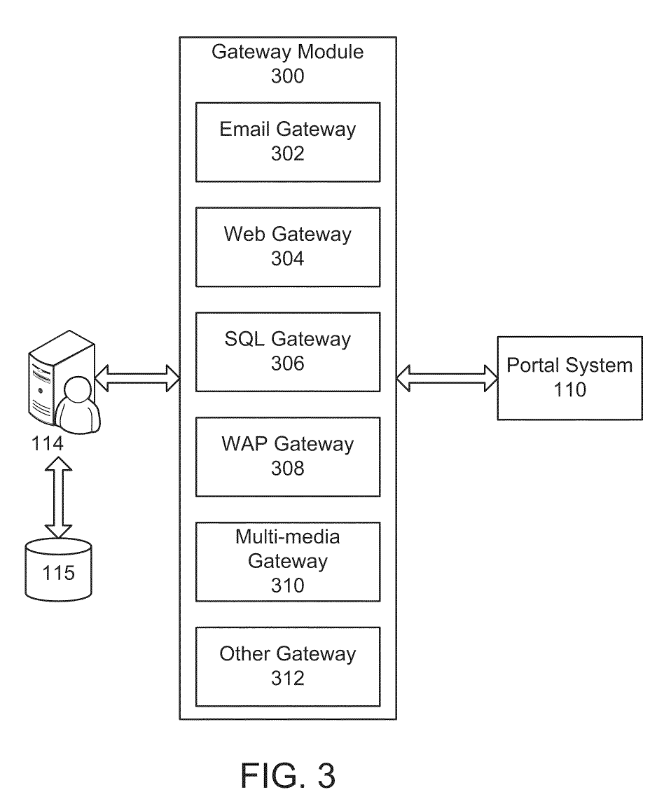

Referring to FIG. 3, a gateway module 300 of the portal system 110 includes multiple communication gateways that allow information to be shared among two or more software applications, functions, processes, and etc. In some implementations, the gateway module 300 includes one or more of an email gateway 302, a web gateway 304, a structured query language (SQL) gateway 306, a wireless access protocol (WAP) gateway 308, a multi-media gateway 310, and other gateways 312. The email gateway 302 is configured to integrate multiple email systems, such that different email systems can communicate with one another. In some implementations, integrating email systems may include use of point-to-point gateways, message switches, and client drivers, individually or in combination.

The web gateway 304 allows use of webs as a data source to automate interactions with web-based services. For example, data from a data source on a website can be retrieved by a legacy application in a client/server architecture without the need to replace or rewrite the entire application.

The SQL gateway 306 can provide a mechanism for users to transparently access data in a variety of data sources (e.g., the proprietary database 126 shown in FIG. 2), by mapping the formats of the SQL and the protocols of different platforms. As such, the portal interface 112 of FIG. 2 can also be used for applications such as a near real-time search engine, through which a user can search within specific domain or the World Wide Web using keywords. In response to a user inquiry, the server 114 may activate appropriate protocols to fetch and store requested information objects in the content repository 115. Due to the dynamic nature of medical content and information, the server 114 may also include a translator to the portal system 110 when incorporating and modifying applications. Additionally, the integration engine 120 may use the integration manager 116 to configure personalized content to further allow the user to efficiently navigate the user's personalized content.

The integrated information can be accessed and shared independent of the location of a user and can eliminate a healthcare professional's need to navigate multiple and disparate applications to locate patient data or other medical information. Medical care can be provided with improved the quality and efficiency. For example, radiologists working at various hospitals are allowed to view relevant patient information by accessing the portal system 110 and the medical content service system 100 to review results of previous examinations of the patient. The centrally stored electronic radiological images can be reviewed independent of the location of the radiologists and the radiologists can also manipulate images. The WAP gateway 308 allows a WAP enabled wireless device, such as cell phone or a personal digital assistant (PDA), to download webpages from the medical content provider 102 (FIG. 2) using a wireless markup language (WML) via the Internet.

The multi-media gateway 310 may translate the SQL entered by the service customers 106 based on data types such as documents, audio, video and images. This feature allows the SQL applications to access non-traditional data formats without changing the data access method for the application. Users can further upload and/or download structured and non-structured data to and from the server 114 through the multi-media gateway 310. For example, after completing the registration process and downloading the medical content from the portal system 110 to a local system, a user can upload the content to the medical content service system 100 to share the resource with other system users.

Other functions of the gateway module can be provided by one or more other gateways 312. For example, the gateway 312 may provide a mechanism for user to access non-relational database and data sets with SQL and data structure. Such a gateway service may automatically establish communications, data mapping, and access methods among different data sources. It can be appreciated that other gateway services, such as interactive voice response (IVR) gateway or conventional fax gateway may also be incorporated into the system.

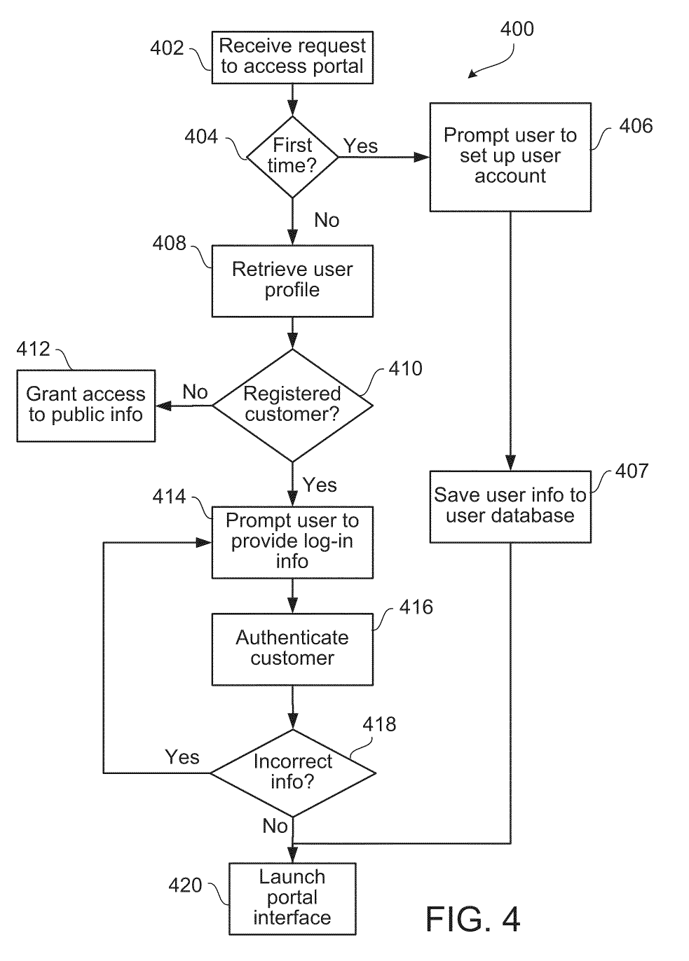

Referring now to FIG. 4, a flowchart 400 represents a particular arrangement of operations of an integration manager (e.g., the integration manager 116 shown in FIG. 2) in providing user authentication and enabling one or more log-on processes. In some implementations, such operations allow the users to access multiple applications and data with one login process, e.g., one user ID and password.

The integration manager receives 402 a request to access the portal system 110. The content manger checks 404 whether the request is from a first-time user. If the user is a first-time user to the portal and the system 100, the integration manager directs the user to a secured registration page and prompts 406 the user to set up a user account. The user may be guided through the set up process by personal information, such as name, address, requests from the secured registration page. The personal information can also include specific user interests and preferences regarding medical information and medical vendors' promotions. The user may also be asked to provide a primary email address, such that a content provider (e.g., the content provider 102) can channel desired medical information to the user through email messages. The integration manager saves 407 the user information in a user database. In some implementations, an account in a central user database is set up and user related information including selected user ID and password is saved to the account. Other information entered by the user and/or derived from the information entered by the user can also be saved in the account in the central user database. For example, if a user indicates regular smoking habits, derived information (e.g., the user may be in a high risk zone for lung cancer) is also saved to the user's account.

If the user is identified as a returning user, the integration manager retrieves 408 a profile of the user and determines 410 whether the user is a registered customer. If the user is not registered, the integration manager grants 412 the non-registered user access to public information, which may only contain limited medical information.

For customers identified as registered, the integration manager prompts 414 the user to enter log-in information. The log-in information may include a username password pair, biometric identification techniques related to fingerprints, retinal scans, or other authentication schemes. The integration manager authenticates 416 the user based on the provided log-in information or authentication credentials. In some implementations, the log-in information is sent to a centralized authentication system. The centralized authentication system may include a user authentication registration application and a user database. The user database may include a previously created user accounts, each containing a user ID for a registered customer and a password associated with the user ID. The user database may also include a number of data records related to a user. For example, in addition to a unique user ID and a password for every user account, the database can further include a question (often referred to as a hint question) and answer that allows a user to regain the access to the associated user account when the user forgets the user ID and/or password. The content manger checks 418 whether the log-in information is incorrect information (e.g., wrong user ID or wrong password). The user may be asked to re-enter the log-in information if the entered log-in information is determined to be incorrect. In some implementations, the user may choose to initiate a log-in information retrieval process if the user has lost the log-in information. In some implementations, an user account may be temporarily locked if too may unsuccessful log-in attempts are detected. In such cases, the user may be directed to appropriate procedures to unlock the account.

The integration manager launches 420 a portal interface for an authorized user who entered correct log-in information. In some implementations, the authentication registration application may retrieve all applications under a specific user account, and allow the user to access, e.g., by email, instant messaging, personal information manager (PIM), and others, in a secured mode. In some implementations, a centralized portal management provides user-friendly control that extends across various web-based applications. In some implementations, the centralized portal management can include navigation buttons to the various content applications the service customer have downloaded or to which is subscribed. The portal layout can be set by the service customer to have a personalized display. The content applications accessed via the portal may operate either on a machine local to the customer or on a hosted environment outside the customer premises.

The systems 100, 200 may provide various advantages based upon their implementation. In one arrangement, clinical staff in a hospital can keep track of critical clinical information such as vital signs and medication administration through the medical content integration service system 200 illustrated in FIG. 2. Physiological monitoring devices automatically provide information to the server 114 and the content repository 115. As clinicians prescribe medications, links to the medical literature and pharmaceutical companies may enable clinicians to review drug and dosing regimen and other relevant information in view of the patient-specific conditions. By providing these links directly within displayed clinical information, the system may save research time for healthcare providers while providing access to the latest medical data.

As illustrated above, portal system 110 makes various types of information accessible to users. The portal system 110 consolidates a vast amount of information from multitude sources onto a single source, and allows connecting various clinical applications to this single portal system 110. For example, a user can review announcements of programs, events, and reports related to medical information. The user can also access medical related news from the medical content providers 102 and clinical information system vendors 104. Access to e-mail messages and accounts, calendars, meeting schedule tools, and other medical content applications may also be provided by the system 110, along with access to smaller portals created and maintained by independent departments within a healthcare environment. A search engine can be incorporated in the system 110 to help users quickly locate information of interest. The display of the information may be customized (e.g., users can specify contents of a page to be displayed).

Additionally, the portal system 110 and the interface 112 may be designed to improve the access to and sharing of the integrated information. For example, self-service publishing features allow end users (e.g., the medical content provider 102 and the clinical information system's vendors 104) to post and share any kind of documents or Web content, including those geographically dispersed, with other users. Certain users can have privileges to modify documents produced by other users or groups. The portal system 110 allows the users to both consume the integrated information and also provide information to be integrated and shared with other users.

In another arrangement, a robust decision-support algorithm can be embedded into the medical content service system 100 to monitor the entered or integrated data and generate alerts, reminders, and suggestions to the users of the system. This feature may provide convenience to clinicians, who may have difficulty with being current in regards to the latest medical information, e.g., due to lack of time. Known information may be forgotten or lost in the overwhelming tasks of day-to-day practice. The clinically relevant alerts and reminders can be provided unobtrusively and the clinicians can benefit from both the collective knowledge of other professionals through the routine operation of the medical content service system 100.

Additionally, a single, unique identifier can be assigned to each patient visiting the hospital. The unique identifier can be saved in a centralized patient repository (not shown) in communication with the server 114. As such, patient information collected from various sources, e.g., different hospital departments and various medical devices, can be saved by using interface 112 in a patient record in the centralized patient repository and identifiable by the unique identifier. The clinicians can access the patient records to view laboratory results, medication records, and allergy information. In some implementations, the clinicians can create and maintain a common patient problem list based on the patient records. The clinicians can also document history and physical examination findings into patient records, complete progress notes, generate reports, and communicate with other clinicians about the patients based on the patient records.

The portal system 110 and the medical content service system 100 can improve the quality and reduce the cost of health care by providing integrated relevant medical information and clinical applications to healthcare providers, administrators, and patients in a timely manner. Care and records of a patient from different facilities (e.g., different medical devices, departments, or hospitals) can be readily tracked and integrated. For example, a patient at a clinic for cough and fever may have samples for blood cultures taken. While these specimens are sent to a laboratory for processing, the patient may be referred to a radiologist for chest radiography. The radiologist can log into the portal system 110 to view the primary care physician's examination notes while performing the radiology examination. At a later time, the primary care physician may note, in the central data repository, that the laboratory results have returned and that the radiologist's note is available. A diagnosis can be relatively quickly determined, past medical history can be reviewed, and the appropriate medication can be formulated.

Convenient access to the integrated patient data may be granted to those who have a legitimate need to review the data. By storing data in a single centralized database or a federated architecture were data can be retrieved on demand from several disparate databases, the medical content service system 100 can enable the clinicians to view comprehensive patient information efficiently using applications provided by computers at the point of care. The ability to view data entered at other facilities may also be realized throughout the portal system 110 and medical content service system 100. A web-based application may allow authorized clinicians to view data at anytime and any location. In addition, an audit trail indicating who has looked at which data may be maintained to ensure that only clinically relevant data are accessed.

The portal system 110 also provides the advantage of having medical content or medical data organized and legible. For instance, laboratory data can be grouped together for easy viewing. The laboratory data can be reformatted and manipulated easily in a variety of ways. For example, the system 100 can display and extrapolate laboratory results graphically to provide viewable trends and that can be used for taking subsequent preventive measures.

In another arrangement, use of an integrated medication-ordering application can also be provided by the medical content service system 100. For example, the physicians are provided with one-click selections of common prescriptions. A legible prescription can be printed and be taken to any community pharmacy or be sent directly to a clinic-based pharmacy for immediate filling. Physicians do not need to write multiple prescriptions by hand when the patient needs a renewal of the prescription. The apparatus, methods, flow diagrams, and structure block diagrams described in this patent document can be implemented in computer processing systems including program code comprising program instructions that are executable by the computer processing system. Other implementations can also be used. Additionally, the flow diagrams and structure block diagrams described in this patent document, which describe particular methods and/or corresponding acts in support of steps and corresponding functions in support of disclosed structural means, can also be utilized to implement corresponding software structures and algorithms, and equivalents thereof.

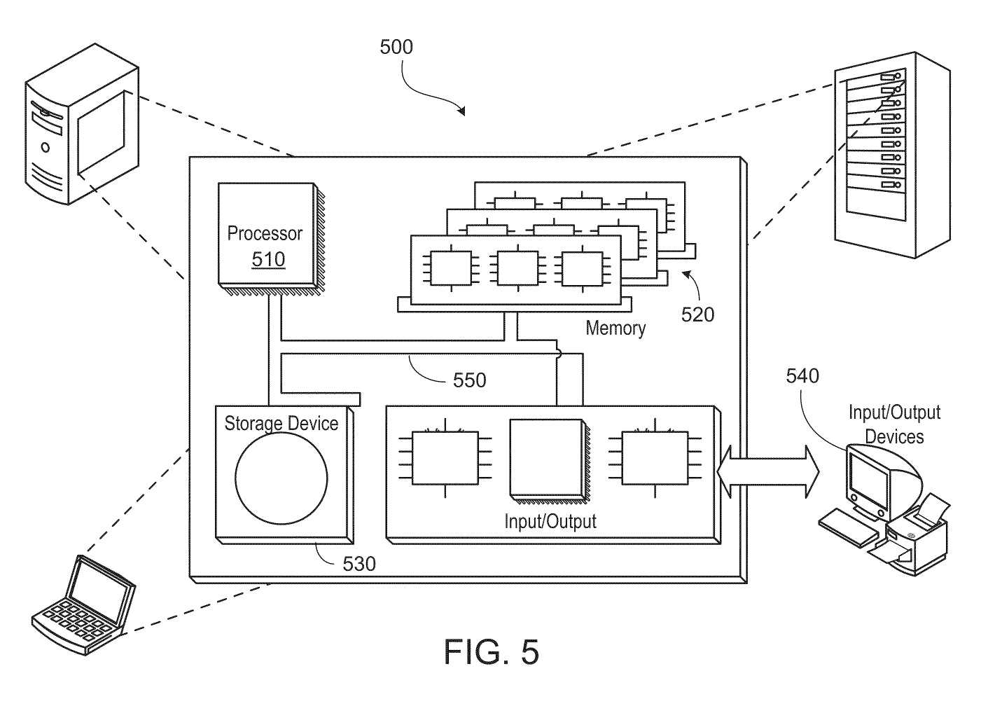

FIG. 5 is a schematic diagram of an example computer processing system 500. The computer processing system 500 can be used for practicing operations described above. The system 500 can include a processor 510, a memory 520, a storage device 530, and input/output devices 540. Each of the components 510, 520, 530, and 540 are interconnected using a system bus 550. The processor 510 is capable of processing instructions within the system 500. These instructions can implement one or more aspects of the systems, components and techniques described above. In some implementations, the processor 510 is a single-threaded processor. In other implementations, the processor 510 is a multi-threaded processor. The processor 510 can include multiple processing cores and is capable of processing instructions stored in the memory 520 or on the storage device 530 to display graphical information for a user interface on the input/output device 540.

The memory 520 is a computer readable medium such as volatile or non volatile that stores information within the system 500. The memory 520 can store processes related to various functionality, for example. The storage device 530 is capable of providing persistent storage for the system 500. The storage device 530 can include a floppy disk device, a hard disk device, an optical disk device, or a tape device, or other suitable persistent storage mediums. The storage device 530 can store the various databases described above. The input/output device 540 provides input/output operations for the system 500. The input/output device 540 can include a keyboard, a pointing device, and a display unit for displaying graphical user interfaces.

The computer system 500 illustrates one example of a computing device. In general, embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet. The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art can effect alterations, modifications and variations to the examples without departing from the scope of the invention.

What is claimed is:

1. A computer implemented method, comprising:
identifying medical information from a plurality of information sources, the medical information having one or more data structures;
converting the data structure of the identified medical information into a predefined data structure; and
presenting the transformed medical information having the predefined data structure.

2. The computer implemented method of claim 1 further comprising periodically updating the medical information from the plurality of information sources.

3. The computer implemented method of claim 1, wherein converting the data structure of the identified medical information comprises resolving data structure discrepancies among the information from the plurality of information sources.

4. The computer implemented method of claim 1, wherein presenting the medical information comprises deploying a portal system that is accessible by a plurality of authorized users within a healthcare environment.

5. The computer implemented method of claim 4, wherein the portal system comprises a communication gateway module configured to manage data flow and control operations on the identified medical information.

6. The computer implemented method of claim 4, wherein the portal system comprises an interface configured to provide access to and enable sharing of the medical information among the plurality of authorized users within a healthcare environment.

7. The computer implemented method of claim 1 further comprising:
assigning each of a plurality of patients a unique identifier;
associating the medical information related to each patient with the unique identifier of the patient; and
accessing medical information of a patient by referencing the unique identifier.

8. The computer implemented method of claim 1, wherein the medical information comprises clinical applications that make use of clinical data.

9. The computer implemented method of claim 1, wherein presenting the transformed medical information comprises enabling a user to browse online a content catalog of the medical information.

10. The computer implemented method of claim 1, further comprising enabling a user to download online content applications of the medical information.

11. The computer implemented method of claim 10, further comprising billing the user for downloading the content applications.

12. A system, comprising:
a server computer including a processor configured to:
identify medical information from a plurality of information sources, the medical information having one or more data structures;
convert the data structure of the identified medical information into a predefined data structure; and
present the transformed medical information having the predefined data structure

13. The system of claim 12 further comprising a data repository for storing the medical information from the plurality of information sources.

14. The system of claim 12, wherein to convert the data structure of the identified medical information comprises resolving data structure discrepancies among the medical information from the plurality of information sources.

15. The system of claim 12 further comprising a portal system in communication with the server computer, the portal system comprising an interface configured to provide access to and enable sharing of the medical information among a plurality of authorized users within a healthcare environment.

16. The system of claim 15, wherein the portal system is deployed within a healthcare environment.

17. The system of claim 15, wherein the portal system comprises a communication gateway module configured to manage data flow and control operations on the identified medical information.

18. The system of claim 12, wherein the processor is configured to periodically update the medical information from the plurality of information sources.

19. The system of claim 12, wherein the processor is configured to:
assign a unique identifier to each of a plurality of patients;
associate medical information that is related to each patient with the unique identifier of the patient; and
access medical information of the patient by referencing the unique identifier.

20. The system of claim 12, wherein the medical information comprises clinical applications that make use of clinical data.

21. The system of claim 12, wherein to present the transformed medical information comprises enabling a user to browse online a content catalog of the medical information.

22. The system of claim 12, wherein the processor is configured to enable a user to download online content applications of the medical information.

23. The system of claim 22, wherein the processor is configured to bill the user for downloading the content applications.

24. A computer-readable medium for storing instructions that are executable by a computer, the execution of the instructions causing the computer to:
identify medical information from a plurality of information sources, the medical information having one or more data structures;
convert the data structure of the identified medical information into a predefined data structure; and
present the transformed medical information having the predefined data structure.

25. The computer-readable medium of claim 24 further comprising causing the computer to store the medical information from the plurality of information sources in a data repository.

26. The computer-readable medium of claim 24, wherein to convert the data structure of the identified medical information comprises resolving data structure discrepancies among the medical information from the plurality of information sources.

27. The computer-readable medium of claim 24 further comprising causing a computer to provide access to and enable sharing of the medical information among a plurality of authorized users within a healthcare environment.

28. The computer-readable medium of claim 24, wherein the computer is deployed within a healthcare environment.

29. The computer-readable medium of claim 24 further comprising causing a computer to manage data flow and control operations on the identified medical information.

30. The computer-readable medium of claim 24 further comprising causing the computer to periodically update the medical information from the plurality of information sources.

31. The computer-readable medium of claim 24 further comprising causing the computer to:
assign a unique identifier to each of a plurality of patients;
associate medical information that is related to each patient with the unique identifier of the patient; and
access medical information of the patient by referencing the unique identifier.

32. The computer-readable medium of claim 24, wherein medical information comprises clinical applications that make use of clinical data.

33. The computer-readable medium of claim 24, wherein to present the transformed medical information comprises enabling a user to browse online a content catalog of the medical information.

34. The computer-readable medium of claim 24, further comprising causing the computer to enable a user to download online content applications of the medical information.

35. The computer-readable medium of claim 34, further comprising causing the computer to bill the user for downloading the content applications.
